(19) United States
(12) Patent Application Publication
(10) Pub. No.: US 2006/0075651 A1
(43) Pub. Date: Apr. 13, 2006

(54) Cap's N Dip's for dummies

(76) Inventors: Friday Verna Marie Hamlet, Box Elder, SD (US); Armagh Michael Francis Xavier Hamlet, Box Elder, SD (US)

Correspondence Address: Friday & Armagh Hamlet, 235 Douglas Road #19, Box Elder, SD, 57719, US

(21) Appl. No.: 10/963,842

(22) Filed: Oct. 12, 2004

(51) Int. Cl. G01F 23/04

(52) U.S. Cl. 33/722

(57) ABSTRACT

Cap's N' Dip's for Dummies would solve the age old problem of mixing up battery cables and fluid portals resulting in premenet and expensive damage to motor vehicle engines. At a glance the lay consumer would be able to locate fluid reservoirs, access portals and identify the negative and positive sides of the battery. The concept behind this solution is to use bright, reflexive, glow-in-the-dark color-coded caps, dipsticks and wide extended battery cable tags as identifying features. An easily visible chart that would facilitate the identification process would be attached to a location within the engine compartment.

### BACKGROUND FIELD OF THE INVENTION

This invention relates to automobile engine fluid portal caps, dipsticks and battery tags. Specifically designed to facilitate the tasks associated locating and monitoring all vehicle fluids and battery cable identification.

### BACKGROUND-PRIOR ART

Automobile manufactures supply consumers with a selection of plastic, mental, steel and aluminum caps and dipsticks for their motor vehicle engines. Such caps and dipsticks are reliable, sever their purpose and are standard in every automobile.

Originally this was adequate because at the time there were plenty of full service stations and consumers did not have to know where everything in the engine was located especially the fluid portals and the dipsticks for those fluids. But full service gas stations are almost a thing of the pass. All the responsibility for vehicle maintenance has shifted to the consumer. Unfortunately our society know longer is made up of two parent house holds and if they are the chances of them have full knowledge of a motor vehicle engine is highly unlikely.

Cap's N Dips for Dummies would be a simple answer to this problem. This invention would, quite plainly, allow a motor vehicle owner to locate fluid reservoirs, their access portals, dipsticks and identify at a glance the positive and negative sides or a battery.

The product concept behind this invention is to use color-coded caps and dipsticks to guide motorist to specific fluid containers. large color-coded easy to identify battery tags that would make it easier to identify the negative from the positive side of the automobile battery. A color-coded easy to read chart would be provided to facilitate the identification of each color used and which cap they belong too. The card could be attached to a location within the engine compartment or simply placed in the glove compartment to the vehicle . . . .

Other inventors have created several different types of dipsticks for the automobile engine. They have severed there propose and have been very useful in the past. U.S. patent to G. H. Lee U.S. Pat. No. 2,771,680 (1955) was a no-wipe oil dipstick. Also, U.S. patent given to M. A. De Witt U.S. Pat. No. 2,279,111 invented a gauge rod wiper. Although inexpensive to manufacture, and capable of detecting fluid levels they are still hard to read and not easily located. these inventions where very ingenious, they did not solved the problem the lay person has locating a particular fluid portal or knowing which dipstick went with (if at all) that fluid reservoir.

Some of the Disadvantages of the Prior Artwork Consist of the Following:
a.) The fluid reservoirs are hard to locate.
b.) Unless the engine of vehicle is kept clean it is very hard to identify the fluid name on the caps.
c.) Battery cables are not sufficiently marked; making it easy to confuse the positive and negative sides of the battery. If you have ever had to jump-start a car you know that if the jumper cables are not properly placed on the battery cables it could cause permit damage to the engine.
d.) Dipsticks are often hard to locate because not all manufactures place them in the same location, making them hard to find.
e.) When attempting to read the measuring end of a dipstick to determine the fluid levels they almost impossible to read.

Objects and Advantages:

Accordingly, besides the objects and advantages of a color-coded system for locating and identifying fluid reservoirs, dipsticks and battery cable tags described in my above patent, several objects and advantages of the present invention are:
1. To provide caps, dipsticks, battery cable tags and a laminated card which can be produced in a variety of colors without requiring the manufacturer to use a compounding facility for the production of pigments
2. to provide a fluid portal cap whose production allows for a convenient
3. to provide battery color-coded battery tags.
4. to provide an easy to read chart that would facilitate the identification of each color used and which fluid they are associated with. The chart could be attached to the inside of the engine hood or kept in the glove compartment of the vehicle. The design of Cap's N Dip's for Dummies calls for metal parts and plastic items to be utilized as its major components. It would be constructed of the best quality materials commonly accepted and used in the manufacturing industry today. The metals used would be selected from available steel or alloys of steel and aluminum. The production process related to the use of these metals would ensure that they were produced so as to be non-corrosive, durable and strong. The selected metals should have high impact strength and be able to accept and retain coloring materials for an extended length of time. Plastic could also be used as a major production material. The plastic used in the production of this invention should also be selected for its durability and lasting traits. Thermoplastics are commonly used in the manufacturing of components similar to those designed for Cap's N Dip's for Dummies. Polyethylene, polypropylene, and other similar thermoplastic materials would be among those considered having the desirable traits. Members of this family are recognized universally as being versatile and as being of high quality.

Objectives and Advantages

Besides the objective of flexible plastic caps and dipstick covers my invention have several objectives and advantages.
(a) The color-coded caps and matching dipstick covers can be any color scheme, including glow in the dark colors, patterns or shapes.
(b) Instead of a cap or a band that covers the original engine
(c) caps and dipsticks they can be made to replace the current automotive fluid cap and its corresponding fluid cap.
(d) Easy to use, especially for single women, single parent h
(e) house holds and knew drivers as well as anyone who has no
(f) knowledge of automobile engines. But not just limited to these target groups.
(g) The actual size and shape of each cap or other fluid measuring instruments would vary from one make and model of the vehicle to another.
(h) The caps and dips concept could be applied to other engines such as those found on lawn mowers, garden tractors, and tillers. (I haven't included the preliminary patent art works for theses small engines)
(i) Easy to see: Cap's and Dips will make it easy to locate the fluid cap and their corresponding dipsticks. By using a different color for each fluid portal and its dipstick would match the fluid cap if it had one.
(j) The battery cable tags although the same original battery cable colors are bigger, and the negative and positive symbols made to stand out and there for be more noticeable and easy to read.

Objects and Advantages: Although all prior artwork for fluid caps and dipsticks are quit capable of getting the job done; they are still hard to locate within the engine. My invention makes them easy to locate, gives you a secure feeling that you have the right fluid reservoir portal and is simple to use. Motor vehicle engines caps and dipsticks are the same colors as it the vehicle engine. Making it easy to replace a fluid with the wrong product. The original cables for the battery, even though same of them are color-coded for both negative and positive they have been mistaken and connecting to the wrong charge has caused permit engine damage. I have done this on several different occasions. The engine jumper cable tags are larger and are easily seen so that when jumper cables are needed to start a motor vehicle there is no doubt which cable is negative and which is positive.

Cap's N Dip's for Dummies would be a simple answer to long time problem. This product would, quite plainly, allow a motor vehicle owner to locate fluid reservoirs and there access ports within the engine compartment with ease and at a glance. And make identifying which battery cable is positive or negative at a quit glance. The product concept behind this solution is to use Color-coded caps and dipsticks as identifying features that would direct the motors to specific fluid containers. An easily visible chart would facilitate the information and identification of each color-coded cap and it would be attached to a location within the engine compartment. The battery cable tags would be easier to see and better identified. Further advantages of Cap's N Dip's for Dummies is that it comes with an easy to read reference card which shows the colors of the fluid caps and lets you know if it has a dipstick or not. In a world where fewer and fewer full service gas stations are still available to the public this product would help automobile drivers fill more competent when it comes to replacing and checking the fluids in their motor vehicles.

### DRAWING FIGURES

In the drawing, closely related figures have the same number but different alphabetic suffixes.

FIG. 1-1A: Show a snap on color-coded cap with three prone attachment legs that can be placed over the existing automotive fluid portal. The two different views of the same cap is to show case the color coding, This cap can also have four prongs if it is deemed necessary for some makes and models of cars.

FIG. 2-2B: Shows a replacement cap that would replace the original fluid cap. Again the color-coding is show cased.

FIG. 3-3C: This is a view of a color-coded dipstick handles; the end of FIG. 3, would be color-coordinated as well to make it easier to read the level of the fluid. (3C) shows one view of how and where the replacement bands can be placed on the dipstick in case the consumer did not want to replace the entire dipstick.

FIG. 4-4D: Are color-coded battery cable tag (s) that clearly display the negative and positive symbols. The negative battery cable tag is not included in artwork at the moment.

FIG. 5-5E: Two plastic rings, which fix over the dipstick handle for those who do not want to replace the entire dipstick. The color-coded bands are show cased from just two bands to the entire dipstick handle with bands that go all the way down the shaft.

FIG. 6: A view of the laminated color-coordinated card which shows all the colors of the caps the fluids they represent and if they have a dipstick that symbol will be shown next to the cap of the same color.

### REFERENCE NUMERALS IN THE DRAWING

1-1A color-coordinated snap on cap

2-2B color-coordinated replacement cap

3 Color-coordinated replacement dipstick with Colored tip for easy to read measuring end

3C view of color-coded bands on the dipstick

4 color-coordinated plastic positive battery tag

4D color-coded negative battery tag

5 two plastic rigs that fix over dipstick handle

6 laminated reference card

### SUMMARY

In accordance with the present invention of color coded caps, dipstick and battery cable tags they are comprised of the best quality materials commonly accepted and used in the manufacturing industry today. The metal used would be selected from available steel or alloys of steel and aluminum. The production process related to the use of these metals would ensure that they were produced so as to be non-corrosive, durable, and strong. The selected meals should have of high impact strength and retain coloring materials for an extended length of time. Plastic could also be used as a major production material. The plastic used in the production of this invention should also be selected for its durability and lasting traits. Thermoplastics commonly used in the manufacturing of components similar to those designed for Cap's N Dip's for Dummies. Polyethylene, polypropylene, and other similar thermoplastic materials would be among those considered having the desirable traits. Members of this family is recognized universally as being versatile and as being of high quality.

Cap's N Dip's for Dummies can come in any color, although glow in-the-dark colors are suggested and can be modified to fit any make and model of car. This invention main objective is to make the fluid re-placement, location and identification more user-friendly to the lay person who is unfamiliar with automobile engines.

Descrition-1 to 6

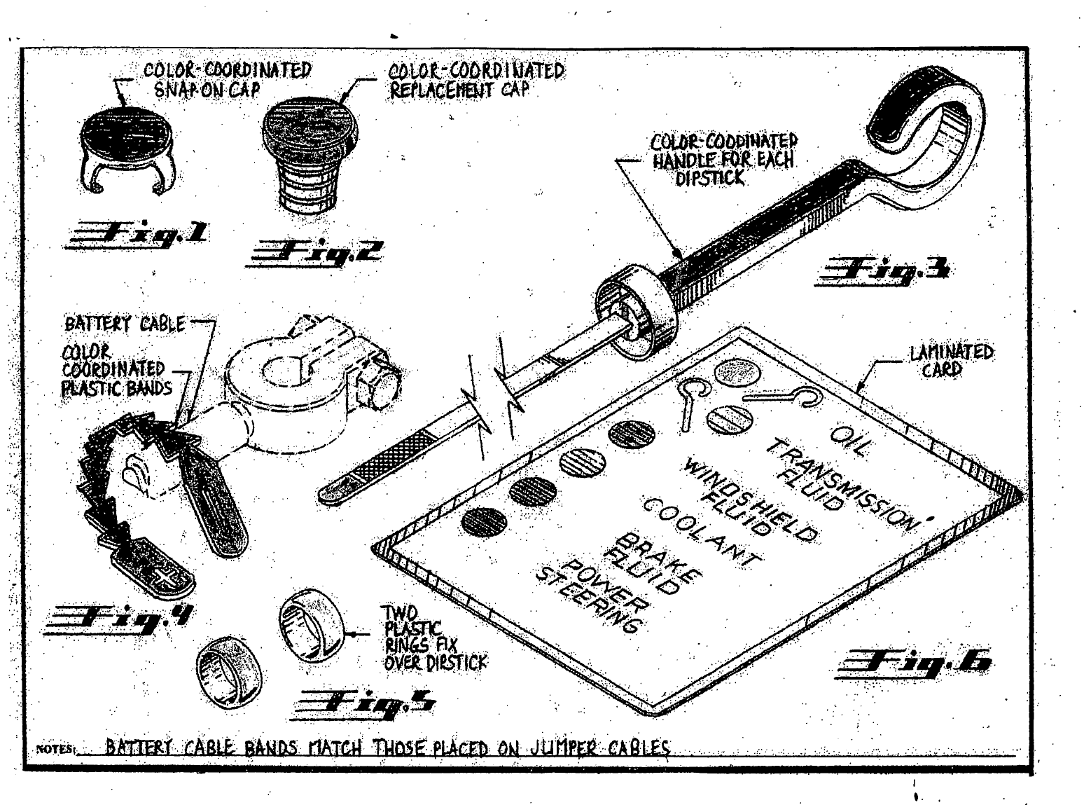

A typical embodiment of the Cap's N Dip's for Dummies of the invention is illustrated in FIG. 1 is a (top view). The portal cap has three prongs that clip on over the existing automotive cap. It consists of a thin flat top with a sheet of material, which is brightly color-coded, will not fracture and has the strength needed to stay in place. Thermoplastic materials chosen for their durability and lasting traits can also be used. FIG. 2 is a (top view) of a color-coded replacement cap. This cap does not snap-on it is a durable portal cap that (depending on the make and model the vehicle) will replace the existing portal cap. FIG. 3 is a (side view) of a color-coded replacement dipstick. The handle of the dipstick as well as the tip of the dipstick is color-coded not only for easy reading and measuring of the fluid being check but for detection as well. FIG. 4 is a (top view) of a color-coded battery cable tag. This tag consists of a flexible sheet of material, which can be repeatedly bent without fracturing it. FIG. 5 is a (side view) of two plastic color-coded rings that fix over the existing dipstick. These are flexible two (or more) color-coded rings that can be placed over the handle of the existing dipstick instead of replacing it completely. FIG. 6 is a (side view) of a laminated color-coded card. Plastic or a thin sheet of metal could be utilized to make this component. Additional embodiments are shown in FIGS. 1a, 2B, 3C, 4D, 5E and 6F; in each case it highlights the use or different colors and the band placement for Cap's N Dip's for Dummies. FIG. 3C is the only exception to the placement of the plastic bands, in this view the bands are metal.

### CONCLUSION, RAMIFICATIONS, AND SCOPE

Accordingly, the reader will see that the invention, Cap's N Dip's for Dummies can be used to detect all the fluid portal reservoirs and their corresponding dipsticks made possible by using brightly colored caps, bands or replacement components. These can be removed just as easily as they were placed over the existing caps and handles. Replacement caps and dipsticks are suggested to replace the current caps and dipsticks at the time of the vehicle are being manufactured. But would also be made accessible to the lay person. In addition to the color-coded caps and dipsticks this invention comes with a laminated easy to read card and two-battery cable tags.

Furthermore the cap's, dips, battery tags and laminated card has the additional advantages in that it permits the caps, bands and replacement components to be produced in a variety of colors without requiring a manufacture to use a separate facility for the compounding of the powered or liquid pigments needed in the production of. colors;

it allows the caps, bands and replacement components to be brighly colored without the need to sacrifice the flexibility of the Invention; it provides caps, band and replacement components with a superior surface upon which an identifying name or symbol can be placed although the description above contains many specifications, these should not construed as limiting the scope of the invention but as merely providing illustrations of some of the presently preferred embodiments of this invention. For example, the caps, bands and replacement components can have other shapes, depending upon which make and model of vehicle they are placed in. Glow in the dark colors can be used to make them easier to see at night. But, any colors can be used and are not just limited to glow-in-the-dark colors. Patterns, tie dye, animal prints, stripes, dots or even floral patterns can be used. The battery cable tags although are color coordinated to correspond with the negative and positive charges of the vehicle battery can also be change, but to make it unless confusing to the lay person they should be red (positive) and black (negative). The laminated card can be made s either out of plastic or metal and can be placed in the glove compartment or attached to the inside of the hook of the vehicle so it can be easily seen. Each cap would also have the standard identifying fluid symbol stamped on the top of its cap.

1. In a vehicle engine portal reservoirs and dipsticks are often hard for the lay person to identify or even locate. This Invention would make it possible to locate and identify the portal and dipsticks at a glance. This Invention would make maintaining, measuring and battery cable detection more user-friendly for the lay person.

2. The caps of claim 1 wherein said body is a snap on color-coded cap with three prongs to stabilize and attach to the existing portal cap.

3. The cap in claim two is a color-coded replacement cap that would be used to replace the existing vehicle cap.

4. Claim 3, is a side view of a color-coordinated dipstick handle. The tip of the dipstick is also color-coded making it easier to read.

5. Claim 4, consists of a view of a positive battery cable tag. The tag attaches to the battery cables by slip the flat end of the tag, which is labeled with either the negative or positive symbol through the slot on the other end of the tag and pulling it tightly though the hole. The are larger, easier to see and easy to identify.

6. Claim 5, is a side angle view of two color-coded bands that can be placed over the handle of a dipstick. These are for people that do not want the added cost of replacing the existing dipsticks in their vehicles.

7. Claim 6, is a laminated thin card that explains the use of the colors, the name of the portals they are used on and lets you know if they have a dipstick or not.
